(19) United States
(12) Patent Application Publication
(10) Pub. No.: US 2010/0167023 A1
(43) Pub. Date: Jul. 1, 2010

(54) INK JET RECORDING METHOD, RECORDED MATTER, INK SET, INK CARTRIDGE, AND INK JET RECORDING APPARATUS

(75) Inventors: Takashi OYANAGI, Matsumoto-shi (JP); Hiroki Nakane, Matsumoto-shi (JP)

Correspondence Address: LADAS & PARRY, 26 West 61st Street, New York, NY, 10023, US

(73) Assignee: SEIKO EPSON CORPORATION

(21) Appl. No.: 12/629,911

(22) Filed: Dec. 3, 2009

(30) Foreign Application Priority Data
Dec. 26, 2008 (JP) 2008-333095

(51) Int. Cl. B05D 5/06; B32B 3/10

(52) U.S. Cl. 428/195.1; 427/256

(57) ABSTRACT

An ink jet recording method records an image by ejecting droplets of a plurality of types of ink compositions and making the droplets adhere to a recording medium using an ink jet recording apparatus. The ink jet recording apparatus is provided with at least a first ink composition and a second ink composition. The first ink composition contains a metallic pigment, and the second ink composition contains the metallic pigment and spherical particles having an average diameter of from 1 to 3 μm.

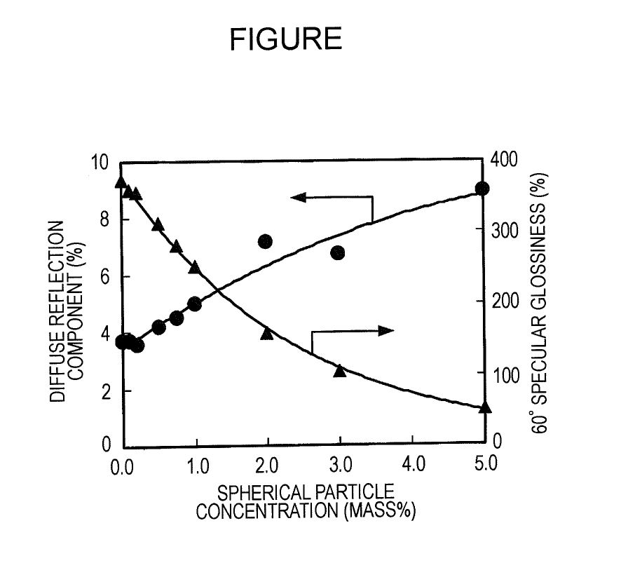

### BACKGROUND

1. Technical Field

The present invention relates to an ink jet recording method, a recorded matter, an ink set, an ink cartridge, and an ink jet recording apparatus.

2. Related Art

In recent years, a demand for printed matters having glossy metallic surfaces on printed surfaces has been increasing. Printed matters having glossy metallic surfaces have characteristics that the duplication thereof is difficult, in addition to the characteristic appearance due to the gloss. For example, copying of a printed matter having a glossy metallic surface by a copier or the like is very difficult because that capture of image information of a glossy metallic surface by an optical scanner is difficult and that toners for enabling reproduction of metallic gloss are not charged.

Glossy metallic surfaces include high glossy specular surfaces and mat glossy surfaces with mat tones. These glossy metallic surfaces each have a variation in glossiness (specular glossiness such as JIS Z8741).

It has been proposed to produce a highly glossy surface by the ink jet recording method. For example, JP-A-2002-179960 discloses a printing technique in which an ink composition containing metal-coated spherical plastic particles as a pigment is applied to a recording medium with an ink jet recording apparatus, and then the surface is smoothed by pressing.

Examples of a known method for forming a mat glossy surface include a gravure printing method and a flexo printing method. In addition, it is known methods in which asperities are formed on a recording medium in advance by, for example, pressing, and then foil stamping or thermal transfer printing is carried out.

Furthermore, an ink jet recording method is known as a significantly efficient method for forming a recorded matter. In the ink jet recording method, droplets of an ink composition are made to fly and adhere to a recoding medium such as paper. This recording method has a feature that a high-resolution and high-quality image can be recorded on various recording media at a high speed.

However, the above-mentioned examples of known printing methods are suitable for forming glossy metallic surfaces having specific degrees of glossiness on printing surfaces. Therefore, it is difficult to form a plurality of glossy metallic surfaces having different degrees of glossiness on a single printing surface as a subject.

In order to form a plurality of glossy metallic surfaces having different degrees of glossiness, the known gravure printing method and flexo printing method are required to change the metallic pigment ink at every plate, and the known foil stamping and thermal transfer printing are required to exchange the plate, the roll, or the like or to prepare exclusive one for forming asperities. Therefore, in the known methods, for example, glossy metallic surfaces are sequentially formed using a plurality of printing apparatuses connected in series, or a structure such as a specific plate or roll is provided to a printing apparatus. Thus, the printing process or the printing apparatus tends to be significantly complicated.

### SUMMARY

The inventors have focused on that the degree of glossiness of a glossy metallic surface varies depending on asperities of the glossy metallic surface and that the asperities can be controlled without changing the type of the metallic pigment, and have arrived at the present invention.

An advantage of some aspects of the invention is to provide an ink jet recording method that can form glossy metallic surfaces having different degrees of glossiness on a recording medium by a single recording process.

The ink jet recording method according to the invention is for recording an image by ejecting droplets of a plurality of types of ink compositions and making the droplets adhere to a recording medium using an ink jet recording apparatus. The ink jet recording apparatus is provided with at least a first ink composition and a second ink composition. The first ink composition contains a metallic pigment, and the second ink composition contains the metallic pigment and spherical particles having an average diameter of from 1 to 3 μm.

By doing so, glossy metallic surfaces having different degrees of glossiness can be formed on a recording medium by a single recording process.

In the ink jet recording method according to the invention, the ink jet recording apparatus may be further provided with a third ink composition containing the metallic pigment and the spherical particles. The content of the spherical particles in the third ink composition may be different from that of the spherical particles in the second ink composition.

In the ink jet recording method according to the invention, the second ink composition and the third ink composition each independently contain the spherical particles and the metallic pigment at a mass ratio of from 1:15 to 10:3.

In the ink jet recording method according to the invention, the recording medium may have a recording surface having an average surface roughness Ra of 0.5 μm or less.

In the ink jet recording method according to the invention, the first ink composition, the second ink composition, and the third ink composition each independently contain the metallic pigment at a content of from 0.5 to 3% by mass based on the total mass of the respective ink composition.

In the ink jet recording method according to the invention, the metallic pigment is a plate-like particle composed of aluminum or an aluminum alloy and having a flat surface with a major axis X, a minor axis Y, and a thickness Z that satisfy the requirements that the 50% average particle size R50 based on a circle-equivalent diameter determined from the X-Y plane area of the plate-like particle is from 0.5 to 3 μm and R50/Z>5.

In the ink jet recording method according to the invention, at least one of the first, second, and third ink compositions may further contain a color material.

In the ink jet recording method according to the invention, the first, second, and third ink compositions each independently have a viscosity of from 2 to 15 mPa·s at 20° C.

A recorded matter according to the invention is one in which an image is recorded on a recording medium by the above-described ink jet recording method.

The thus-obtained recorded matter has glossy metallic surfaces having different degrees of glossiness.

An ink set according to the invention includes a plurality of types of ink compositions used in the above-described ink jet recording method.

An ink cartridge according to the invention includes the ink set.

An ink jet recording apparatus includes the ink cartridge.

### BRIEF DESCRIPTION OF THE DRAWING

The invention will be described with reference to the accompanying drawing, wherein like numbers reference like elements.

The FIGURE shows a graph in which the diffuse reflection components and the specular glossiness of specimens of experimental examples are plotted.

### DESCRIPTION OF EXEMPLARY EMBODIMENTS

A preferred embodiment of the invention will be described in detail below.

### 1. Ink Jet Recording Method

In the ink jet recording method of the embodiment, an image is recorded by ejecting droplets of a plurality of types of ink compositions and making the droplets adhere to a recording medium using an ink jet recording apparatus. The ink jet recording apparatus is provided with at least a first ink composition and a second ink composition.

### 1.1. Ink Jet Recording Apparatus

Any ink jet recording apparatus can be used in the recording method of the embodiment without particular limitation as long as the ink jet recording apparatus can record information by ejecting droplets of an ink composition and making the droplets adhere to a recording medium and can be provided with a plurality of types of ink compositions.

Examples of the recording system of the ink jet recording apparatus include a system in which a strong electric field is applied between a nozzle and an acceleration electrode disposed ahead of the nozzle to sequentially eject ink droplets from the nozzle, and in which printing information signals are applied to deflection electrodes, for recording, while the ink droplets are traveling between the deflection electrodes; a system (electrostatic attraction system) in which ink droplets are ejected according to printing information signals without deflecting the ink droplets; a system in which an ink solution is applied with a pressure by a small-sized pump, and in which a nozzle is mechanically vibrated using a quartz oscillator or the like to forcedly eject ink droplets; a system (piezoelectric system) in which an ink solution is simultaneously applied with a pressure and a printing information signal by a piezoelectric element for ejecting ink droplets for recording; and a system (thermal jet system) in which an ink solution is heated with a microelectrode according to printing information signals to form foam for ejecting ink droplets for recording.

Examples of the ink jet recording apparatus used in the embodiment includes one having an ink jet recording head, a body, a tray, a head-driving mechanism, a carriage, and an ultraviolet irradiation unit mounted on a side face of the carriage. The ink jet recoding head may be configured to include an ink cartridge that receives an ink set of at least four colors of cyan, magenta, yellow, and black so as to be capable of full-color printing. In the embodiment, an ink cartridge being filled with at least a first ink composition and a second ink composition (the both will be described below) is set. In addition, another cartridge can be further filled with a third ink composition or common inks. The ink jet recording apparatus is provided with, for example, an exclusive control board in the inside thereof for controlling the ink ejection timing of the ink jet recording head and the scanning of the head-driving mechanism.

### 1.2. Recording Medium

Any recording medium can be used in the embodiment without particular limitation as long as droplets of each ink composition can adhere thereon by an ink jet recording apparatus. Examples of the recording medium include absorptive recording media such as paper, film, and cloth and nonabsorptive recording media such as metal, glass, and plastic. The absorptive media and the nonabsorptive media are selected depending on components contained in each ink composition. In addition, the recording medium may be, for example, colorless transparent, translucent, colored transparent, chromatic opaque, or achromatic opaque.

The recording medium may be any of gloss, mat, and dull types. Examples of commercially available recording medium include pearl coat paper (available from Mitsubishi Paper Mills Ltd.), aurora coat paper (available from Nippon Paper Industries Co., Ltd.), glossy vinyl chloride sheets (for example, trade name: SP-SG-1270C, manufactured by Roland DG Corporation), and PET films (for example, trade name: XEROX FILM (without frame), manufactured by Fuji Xerox Co., Ltd.).

The use of a recording medium having a smooth printing surface, for example, the use of surface-treated paper such as coat paper, art paper, or cast coat paper or a plastic film such as a vinyl chloride sheet or a PET film can easily form a metallic surface having a high degree of glossiness and can broaden the glossiness variable range of a glossy metallic surface to be formed on a recording medium. The smoothness of a printing surface in this case can be evaluated by, for example, the average surface roughness Ra of the printing surface. In order to broaden the glossiness variable range of a glossy metallic surface to be formed on a recording medium, the average surface roughness Ra of the recording surface of the recording medium is preferably 0.5 μl or less. The average surface roughness Ra can be measured with, for example, a common surface roughness meter.

Examples of the coat paper include those in which a white paint is applied to at least one surface of a base of high-quality paper or medium-quality paper at 7 to 20 g/m². Such coat paper is sometimes called high-quality coat paper or medium-quality coat paper. Furthermore, examples of types of the coat paper include light coat paper in which the amount of an applied white paint is small (for example, about 7 g/m² per one surface), mat coat paper whose glossiness is low, and mirror coat paper whose surface glossiness is high.

Examples of the art paper include paper in which at least one surface of high-quality paper is coated with about 20 g/m² of a white paint and is applied with a high pressure with a roller or the like to give a smooth surface. For example, the art paper includes mat art paper, high-quality art paper, and medium-quality art paper. Examples of the cast coat paper include paper in which at least one surface of high-quality paper is coated with at least 22 g/m² of a white paint and is applied with a high pressure with a roller or the like to give a smooth surface.

### 1.3. Ink Composition

In the ink jet recording method of the embodiment, at least the first ink composition and the second ink composition are charged on the ink jet recording apparatus and are used.

### 1.3.1. First Ink Composition

The first ink composition contains a metallic pigment.

### 1.3.1. (1) Metallic Pigment

Any metallic pigment can be used as the metallic pigment contained in the first ink composition within a range in which droplets of the first ink composition can be ejected by the ink jet recording apparatus. The metallic pigment has a function providing metallic gloss to an adhering substance when the first ink composition adheres onto a recording medium.

The metallic pigment is particles made of, for example, at least one selected from simple metals such as aluminum, silver, gold, platinum, nickel, chromium, tin, zinc, indium, titanium, and copper, their alloys, and mixtures thereof. The metallic pigment used in the embodiment is more preferably aluminum or an aluminum alloy from the viewpoint of performance of reflecting light and cost effectiveness. In the case of using an aluminum alloy, any metallic or nonmetallic element having metallic gloss may be added to aluminum without particular limitation. Examples of the element include silver, gold, platinum, nickel, chromium, tin, zinc, indium, titanium, and copper, and at least one selected from them can be preferably used.

The metallic pigment has a size such that droplets of the ink composition can be ejected by an ink jet recording apparatus. The average particle size (diameter) based on the spherical-equivalent of the metallic pigment particle may be, for example, from 0.5 to 10 μm, and is more preferably from 0.5 to 5 μm.

The content of the metallic pigment is, based on the total mass of the first ink composition, preferably from 0.1 to 5% by mass, more preferably from 0.25 to 4% by mass, more preferably from 0.5 to 3% by mass, and particularly preferably from 0.7 to 2% by mass.

It is further preferable that the metallic pigment be a so-called plate-like particle. The use of such a metallic pigment can further increase the degree of glossiness in an adhering substance formed on a recording medium. In addition, the use of such a metallic pigment can reduce the metallic pigment in the ink composition in the amount necessary for exhibiting a function of reflecting light. Therefore, the viscosity of the ink composition can be reduced, resulting in an enhancement of applicability of the ink composition to an ink jet recording method.

Here, the term “plate-like particle” refers to a particle having an approximately flat surface (X-Y plane) and an approximately uniform thickness. A metallic pigment produced by pulverizing a deposited metal film can be particles having approximately flat surfaces and approximately uniform thicknesses. Accordingly, in the plate-like particle, the major axis and the minor axis of the flat surface and the thickness are defined as X, Y, and Z, respectively.

When the metallic pigment is a plate-like particle, the major axis X, the minor axis Y, and the thickness Z of the plate-like particle preferably satisfy the requirements that the 50% average particle size R50 based on a circle-equivalent diameter determined from the X-Y plane area of the plate-like particle is from 0.5 to 3 μm and R50/Z>5. The 50% average particle size R50 is more preferably from 0.75 to 2 μm. A 50% average particle size R50 less than 0.5 μm may cause insufficient performance in the function of reflecting light. On the other hand, a 50% average particle size R50 higher than 3 μm may cause a reduction in printing stability in ink jet recording. The relationship between the 50% average particle size R50 based on the circle-equivalent diameter and the thickness Z preferably satisfies the requirement of R50/Z>5. When the requirement of R50/Z>5 is satisfied, a metal layer having a high degree of glossiness can be formed. When the R50/Z is not higher than 5, the printing stability in ink jet recording may be decreased.

The maximum particle size Rmax based on a circle-equivalent diameters determined from the X-Y plane areas of the plate-like particles is preferably 10 μm or less from the viewpoint of preventing clogging of the ink composition in an ink jet recording apparatus. By regulating the Rmax to 10 μm or less, clogging in, for example, the nozzle of an ink jet recording apparatus and a foreign material-removing filter disposed in an ink channel can be prevented.

Here, the term “circle-equivalent diameter” refers to, when the approximately flat surface (X-Y plane) of the plate-like particle is supposed to be a circle having the same projected area as that of the plate-like particle, the diameter of the circle. For example, when the approximately flat surface (X-Y plane) of the plate-like particle is polygonal, the projected area of the polygon is converted into a circle having the same area thereas, and the diameter of the circle is the circle-equivalent diameter.

The 50% average particle size R50 of the circle-equivalent diameters of plate-like particles refers to the circle-equivalent diameter at the 50% point of the total number of the measured particles in a number (frequency) distribution of the particles drawn with respect to the circle-equivalent diameters.

The major axis X, the minor axis Y, and the circle-equivalent diameter of the plate-like particle can be measured with, for example, a particle image analyzer. As the particle image analyzer, for example, a flow particle image analyzer, FPIA-2100, FPIA-3000, or FPIA-3000S, manufactured by Sysmex Corp. can be used.

The plate-like metallic pigment can be produced, for example, from a composite pigment base substrate having a structure in which a peeling resin layer and a metal or metal compound layer are sequentially laminated on a surface of a sheet-like base material, by peeling the metal or metal compound layer from the sheet-like base material at the interface between the metal or metal compound layer and the peeling resin layer, and pulverizing the metal or metal compound layer into plate-like particles reduced in size.

The metal or metal compound layer is preferably formed by vacuum deposition, ion plating, or sputtering. The metal or metal compound layer is preferably formed so as to have a thickness of from 20 to 100 nm. Such a thickness can give a pigment having an average thickness of from 20 to 100 nm. By regulating the thickness to 20 nm or more, performances such as reflectivity and glossiness are increased. On the other hand, by regulating the thickness to 100 nm or less, an increase in apparent specific gravity is prevented, resulting in an increase in dispersion stability of the metallic pigment in the ink composition.

The peeling resin layer of the composite pigment base substrate is an undercoat layer of the metal or metal compound and functions as a peeling layer for enhancing the peeling properties from the surface of the sheet-like base material. The resin used in the peeling resin layer is preferably, for example, polyvinyl alcohol, polyvinyl butyral, polyethylene glycol, polyacrylic acid, polyacryl amide, a cellulose derivative, an acrylic acid polymer, or a denatured nylon resin.

The peeling resin layer can be formed by applying a solution of a resin or a mixture of resins for peeling onto a sheet-like base material and drying to form a layer.

After the application, an additive, such as a viscosity modifier, may be added. The application of the peeling resin layer can be performed by a generally used method such as gravure coating, roll coating, blade coating, extrusion coating, dip coating, or spin coating. After the application and drying, if necessary, the surface may be smoothed by calender treatment.

The thickness of the peeling resin layer is not particularly limited, but is preferably from 0.5 to 50 μm, more preferably from 1 to 10 μm. A thickness smaller than 0.5 μm is an insufficient amount as a dispersion resin. A thickness larger than 50 μm may cause peeling at an interface with the metal or metal compound layer when rolled.

The sheet-like base material is not particularly limited, and examples thereof include release films, for example, polyester films such as polytetrafluoroethylene, polyethylene, polypropylene, and polyethylene terephthalate; polyamide films such as Nylon 66 and Nylon 6; polycarbonate films, triacetate films, and polyimide films. Among them, preferred are polyethylene terephthalate and copolymers thereof.

The thickness of the sheet-like base material is not particularly limited, but is preferably from 10 to 150 μm. A thickness of 10 μm or more exhibits satisfactory qualities for handling in steps and the like, and a thickness of 150 μm or less provides sufficient flexibility and hardly causes problems in, for example, rolling and peeling.

Furthermore, the metal or metal compound layer may be provided between protection layers, as described in JP-A-2005-68250. Examples of the protection layers include silicon oxide layers and protection resin layers.

The silicon oxide layer is not particularly limited as long as the layer contains silicon oxide, but is preferably formed of an silicon alkoxide such as tetraalkoxy silane or a polymer thereof by a sol-gel method. A coating film serving as the silicon oxide layer is formed by applying an alcohol solution dissolving a silicon alkoxide or a polymer thereof, followed by heating and baking.

The protection resin layer is made of a resin not being dissolved in a dispersion medium without particular limitation. Examples of the resin include polyvinyl alcohol, polyethylene glycol, polyacrylic acid, polyacryl amide, and cellulose derivatives. Among them, polyvinyl alcohol and cellulose derivatives are preferred.

The protection resin layer can be formed by applying an aqueous solution of a protection resin or a mixture of protection resins, followed by drying. The application solution may contain an additive, such as a viscosity modifier. The application of silicon oxide and a resin can be performed by the same method as in the application of the peeling resin layer.

The thickness of the protection layer is not particularly limited, but is preferably in the range of from 50 to 150 nm. A thickness smaller than 50 nm may cause insufficient mechanical strength, but a thickness larger than 150 nm may cause difficulties in pulverization and dispersion due to too high strength and further may cause peeling at an interface with the metal or metal compound layer.

Furthermore, a color material layer may be provided between the “protection layer” and the “metal or metal compound layer”, as described in JP-A-2005-68251.

The color material layer is provided for obtaining an arbitrary colored composite pigment and is not particularly limited as long as it can contain a color material that can impart arbitrary tone and hue to the composite pigment, in addition to the light-reflecting function, metallic gloss, and brilliance of the metallic pigment used in the embodiment. The color material used in the color material layer may be either a dye or a pigment, and known dyes and pigments can be suitably used.

The “pigment” used in the color material layer in this case indicates that defined in the field of general engineering, such as natural pigments, synthetic organic pigments, and synthetic inorganic pigments.

The formation method of the color material layer is not particularly limited, but is preferably formed by coating. When the color material in the color material layer is a pigment, it is preferable that the layer further contain a color material-dispersing resin. The color material layer containing the color material-dispersing resin is preferably produced by dispersing or dissolving the pigment, a color material-dispersing resin, and other additives, according to need, in a solvent, forming a uniform liquid film of the resulting solution by the spin coating, and drying to form a thin resin layer. Note that it is preferable from the work efficiency that both the color material layer and the protection layer be formed by coating in the step of producing the composite pigment base substrate.

The composite pigment base substrate may have a layer configuration having a plurality of structures in which the peeling resin layer and the metal or metal compound layer are sequentially laminated. The total thickness of the laminar structure composed of a plurality of metal or metal compound layers, that is, the thickness of (metal or metal compound layer/peeling resin layer/metal or metal compound layer) or (peeling resin layer/metal or metal compound layer) excluding the sheet-like base material and the peeling resin layer directly thereon is preferably 5000 nm or less. A thickness not larger than 5000 nm hardly causes chapping and peeling in the composite pigment base substrate even when it is rolled and thus provides excellent storage properties. In addition, excellent glossiness is maintained after being formed into a pigment, which is preferred. Furthermore, a structure in which the peeling resin layer and the metal or metal compound layer are sequentially laminated on each of the both surfaces of the sheet-like base material is another example. However, the structure is not limited thereto.

The peeling method from the sheet-like base material is not particularly limited. Preferred is a method in which the composite pigment base substrate is immersed in a liquid for peeling or a method in which the composite pigment base substrate is immersed in a liquid and is simultaneously sonicated for performing peeling and pulverization of the peeled composite pigment.

In the thus-obtained metallic pigment formed into plate-like particles, the peeling resin layer functions as protective colloid, and thereby a stable dispersion can be obtained by only performing dispersion treatment in a solvent. When the metallic pigment is contained in the first ink composition of the embodiment, the resin derived from the peeling resin layer also can have a function of providing an adhesive property to the metallic pigment against a recording medium or a spherical particle.

### 1.3.1. (2) Additional Components

The first ink composition of the embodiment can contain additional components, for example, a color material, a dispersing agent, an organic solvent, a polymerizable compound, a polymerization initiator, and a surfactant. Among them, the polymerizable compound and the polymerization initiator are usually contained as a combination. In addition, when the organic solvent is contained, the ink composition is a so-called solvent-based ink composition. In such a case, the polymerizable compound and the polymerization initiator are scarcely contained, and a resin component serving as a binder is sometimes contained. Furthermore, when the polymerizable compound and the polymerization initiator are contained, the ink composition is an energy curing ink composition. In such a case, the organic solvent is scarcely contained, and, for example, a polymerization enhancer or a polymerization inhibitor is sometimes contained.

Additional components that can be contained in the first ink composition will be described in order below. These components can be contained in the first ink composition without any limitation as long as the metallic gloss of a recorded matter is not impaired.

### (2-1) Color Material

The first ink composition can contain a color material. The color material may be either a dye or a pigment. By containing the color material in the first ink composition, an image having not only metallic gloss and also color can be formed on a recording medium.

Examples of the dye that can be used in the first ink composition include various dyes that are generally used in ink jet recording, such as direct dyes, acid dyes, food dyes, basic dyes, reactive dyes, disperse dyes, vat dyes, soluble vat dyes, and reactive disperse dyes.

Examples of the pigment that can be used in the first ink composition include inorganic pigments and organic pigments. As the inorganic pigment, in addition to titanium oxide and iron oxide, carbon black produced by a known method such as a contact method, a furnace method, or a thermal method can be used. As the organic pigment, for example, azo pigments (including azolake, insoluble azo pigments, condensed azo pigments, and chelate azo pigments), polycyclic pigments (for example, phthalocyanine pigments, perylene pigments, perinone pigments, anthraquinone pigments, quinacridone pigments, dioxazine pigments, thioindigo pigments, isoindolinone pigments, and quinoflarone pigments), dye chelates (for example, basic dye chelates and acid dye chelates), nitro pigments, nitroso pigments, and aniline black can be used.

As specific examples of the pigment, examples of carbon black include C.I. Pigment Black 7; No. 2300, No. 900, MCF88, No. 33, No. 40, No. 45, No. 52, MA7, MA8, MA100, and No. 2200B manufactured by Mitsubishi Chemical Corporation; Raven 5750, 5250, 5000, 3500, 1255, and 700 manufactured by Columbia Chemical Co.; Regal 400R, 330R, and 660R, Mogul L and 700, and Monarch 800, 880, 900, 1000, 1100, 1300, and 1400 manufactured by Cabot Corp.; and Color Black FW1, FW2, FW2V, FW18, and FW200, Color Black 5150, 5160, and 5170, Printex 35, U, V, and 140U, and Special Black 6, 5, 4A, and 4 manufactured by Degussa Co.

Examples of yellow pigments include C.I. Pigment Yellow 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213, and CHROMOPHTAL YELLOW LA2 (manufactured by Chiba Specialty Chemicals Inc.).

Examples of magenta pigments include C.I. Pigment Red 5, 7, 12, 48 (Ca), 48 (Mn), 57 (Ca), 57:1, 112, 122, 123, 168, 184, 202, and 209, C.I. Pigment Violet 19, and Hostaperm Pink E02 (manufactured by Clariant Japan K.K.).

Furthermore, examples of cyan pigments include C.I. Pigment Blue 1, 2, 3, 15:3, 15:4, 60, 16, and 22, and TGR-SD (manufactured by DIC Corporation).

Furthermore, the first ink composition may contain a white pigment. The white pigment may be, for example, at least one selected from hollow resin particles and metal oxide particles. The hollow resin particles are not particularly limited and may be a known one. For example, the hollow resin particles described in U.S. Pat. Nos. 4,880,465 and 3,562,754 can be preferably employed. Examples of the metal oxide particles include those made of titanium dioxide or zinc oxide (zinc white).

In the first ink composition containing a pigment, the average particle size of the pigment is preferably in the range of from 10 to 200 nm, more preferably about from 50 to 150 nm. In the first ink composition containing a color material, the content of the color material is preferably in the range of about from 0.1 to 25% by mass, more preferably in the range of about from 0.5 to 15% by mass.

In addition, the first ink composition containing a pigment can further contain a dispersing agent or a surfactant. Preferred dispersing agents are those commonly used for preparing pigment dispersions, for example, polymer dispersing agents. Examples of the polymer dispersing agents include SOLSPERSE 13940 manufactured by Lubrizol Corporation.

### (2-2) Organic Solvent

The first ink composition can contain an organic solvent. The organic solvent is preferably a polar organic solvent, and examples thereof include alcohols (for example, methanol, ethanol, propanol, butanol, isopropanol, and fluorinated alcohols), ketones (for example, acetone, methyl ethyl ketone, and cyclohexanone), carboxylic acid esters (for example, methyl acetate, ethyl acetate, propyl acetate, butyl acetate, methyl propionate, and ethyl propionate), and ethers (for example, diethyl ether, dipropyl ether, tetrahydrofuran, and dioxane). Among them, alkylene glycol ethers are liquid at ordinary temperature and pressure and are therefore preferred.

Examples of the alkylene glycol include aliphatic ethers of methyl, n-propyl, isopropyl, n-butyl, isobutyl, hexyl, and 2-ethylhexyl; ethylene glycol ethers including, as the base, an allyl or phenyl group having a double bond; and propylene glycol ethers. Since these alkylene glycols are colorless and low in odor and have an ether group and a hydroxyl group in each molecule, they have both characteristics from the alcohols and the ethers and are liquid at ordinary temperature and pressure and are therefore preferred. In addition, monoethers in which only one hydroxyl group is substituted and diethers in which both hydroxyl groups are substituted can be used in a combination thereof.

The organic solvent contained in the first ink composition is preferably at least one selected from mixtures of alkylene glycol monoethers, alkylene glycol diethers, and lactones.

Examples of the alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Furthermore, examples of the lactones include γ-butyrolactone, δ-valerolactone, and ε-caprolactone.

When the first ink composition contains one or more of the above-exemplified organic solvents, the total amount of the organic solvents is, for example, from 50 to 99% by mass based on the total mass of the first ink composition.

The first ink composition containing the organic solvents can further contain a resin serving as a binder. Examples of the resin include cellulose ester resins such as cellulose acetate (CA), cellulose acetate propionate (CAP), cellulose acetate butyrate (CAB), cellulose propionate (CP), and cellulose triacetate (CAT).

In the first ink composition containing a binder resin, the binder resin can show a function of protecting an adhering substance from friction and the like when the first ink composition adheres onto a recording medium.

### (2-3) Polymerizable Compound

The first ink composition can contain a polymerizable compound and a polymerization initiator. The polymerizable compound can have cationic polymerizability and/or radical polymerizability. The polymerization initiator is an initiator for the cationic polymerization and radical polymerization and is properly selected depending on the type of the polymerizable compound. The addition of these compounds can enhance, for example, the abrasion resistance of an adhering substance formed by each ink composition adhering to a recording medium. The polymerization initiator will be described below. The polymerizable compound may be in any form of a monomer, an oligomer, a linear polymer, and a dendritic oligomer.

Examples of the cationic polymerizable compound that can be used in the first ink composition include compounds having cationic polymerizable functional groups. Examples of the cationic polymerizable functional groups include epoxy rings (for example, groups having structures of an aromatic epoxy group or an alicyclic epoxy group), oxetane rings, oxorane rings, dioxorane rings, and vinyl ether structures, and functional groups having such structures. Regarding the epoxy rings, aromatic and alicyclic epoxy rings are preferred from the viewpoint of their high curing rates, and the alicyclic epoxide rings are particularly preferred. Furthermore, regarding the polymerizable compounds, those having a plurality of cationic polymerizable functional groups are preferred from the viewpoints of the reaction rate and the curing properties.

Examples of the cationic polymerizable compound include various known cationic polymerizable compounds that start polymerization by initiating species (acid), such as epoxy compounds, vinyl ether compounds, and oxetane compounds.

Examples of the epoxy compounds include monofunctional or polyfunctional aromatic epoxides and alicyclic epoxides, and the alicyclic epoxides are particularly preferred from the viewpoint of their excellent curing rates.

Examples of the vinyl ether compounds include monofunctional or polyfunctional vinyl ethers. Di- or tri-vinyl ether compounds are preferred from their excellent curing rates, and the divinyl ether compounds are particularly preferred.

Examples of the oxetane compounds include compounds having monofunctional or polyfunctional oxetane rings, for example, oxetane compounds described in JP-A-2001-220526, JP-A-2001-310937, and JP-A-2003-341217.

The compounds having oxetane rings are preferably polyfunctional compounds. By employing such compounds, the viscosity of the ink composition can be readily maintained within the range that provides excellent handling ability, and also the adhesion of the cured ink to a recording medium can be enhanced. Such compounds having oxetane rings are described in detail in paragraphs [0021] and [0084] of JP-A-2003-341217, and the compounds described therein can be suitably applied to the first ink composition.

Examples of the radical polymerizable compound that can be used in the first ink composition include compounds having radical polymerizable functional groups. Examples of the radical polymerizable functional groups include functional groups each having a double bond in the structure thereof, such as (meth)acryloyl groups, (meth)acryl groups, (meth)acrylamide groups, vinyl groups, aromatic vinyl groups, acryl groups, N-vinyl groups, vinyl ester groups (for example, groups each having, for example, vinyl acetate, vinyl propionate, or vinyl versatate structure), allyl ester groups (for example, groups each having an allyl acetate structure), halogen-containing vinyl groups (for example, groups each having a vinylidene chloride or vinyl chloride structure), groups having vinyl ether structures (for example, groups each having methyl vinyl ether, butyl vinyl ether, hexyl vinyl ether, methoxy vinyl ether, 2-ethylhexyl vinyl ether, methoxyethyl vinyl ether, cyclohexyl vinyl ether, or chloroethyl vinyl ether structure), and vinyl cyanide groups (for example, groups each having a (meth)acrylonitrile structure). In the specification, “(meth)acrylate” refers to one or both of “acrylate” and “methacrylate”, and “(meth)acryl” refers to one or both of “acryl” and “methacryl”, depending on cases.

Among the above-exemplified radical polymerizable functional groups, functional groups having ethylene unsaturated double bonds are highly polymerizable and are therefore further preferred for enhancing the curing rate and the curing properties of a printed surface. In addition, these groups are hardly affected by oxygen inhibition. Consequently, they can be cured by relatively low energy and are therefore further preferred. Examples of the functional groups having ethylene unsaturated double bonds include vinyl groups and allyl groups. Furthermore, the radical polymerizable compounds having a plurality of radical polymerizable functional groups are more preferred from the viewpoints of the reaction rate and the curing properties.

Examples of the radical polymerizable compound include various known radical polymerizable compounds that start polymerization by initiating species (radical), such as (meth)acrylates, (meth)acrylamides, aromatic vinyls, compounds having allyl groups, and compounds having N-vinyl groups. In addition, examples of the radical polymerizable compound include vinyl esters (for example, vinyl acetate, vinyl propionate, and vinyl versatate), allyl esters (for example, allyl acetate), halogen-containing monomers (for example, vinylidene chloride and vinyl chloride), vinyl ethers (for example, methyl vinyl ether, butyl vinyl ether, hexyl vinyl ether, methoxy vinyl ether, 2-ethylhexyl vinyl ether, methoxyethyl vinyl ether, cyclohexyl vinyl ether, and chloroethyl vinyl ether), vinyl cyanides (for example, (meth)acrylonitrile), and olefins (for example, ethylene and propylene).

Furthermore, the radical polymerizable compound may be a dendritic oligomer. Examples of the dendritic oligomer include those in which a polyfunctional (meth)acrylate compound and a polyvalent mercapto compound are polymerized by Michael addition (n-position with respect to a carbonyl group). The dendritic oligomer preferably has a functional group at an amount sufficient for radical polymerization. Accordingly, the molecular weight of the dendritic oligomer is preferably within the range of 100 to 100000 as the molecular weight per mole of carbon-carbon double bond. In addition, the dendritic oligomer preferably has a weight average molecular weight of from 1000 to 60000, more preferably from 1500 to 60000, and particularly preferably from 10000 to 60000.

A specific example of the dendritic oligomer that can be used in the first ink composition is available from Osaka Organic Chemical Industry Ltd. under a trade name of “STAR501”. When the first ink composition contains a dendritic oligomer, the content of the dendritic oligomer is about from 1 to 50% by mass, more preferably from 5 to 30% by mass, based on the total mass of the first ink composition.

The polymerizable compounds can be used alone or as a mixture thereof for adjusting the polymerization rate, ink properties, cured film properties, and so on.

The polymerizable compounds that can be used in the first ink composition may be one in which a radical polymerizable functional group is introduced into a compound having a cationic polymerizable functional group or in which a cationic polymerizable functional group is introduced into a compound having a radical polymerizable functional group.

When the first ink composition contains a polymerizable compound, the content of the polymerizable compound is suitably in the range of from 50 to 99% by mass, preferably from 60 to 98% by mass, based on the total mass of the first ink composition.

### (2-4) Polymerization Initiator

The first ink composition containing a polymerizable compound may suitably contain a polymerization initiator. Examples of the polymerization initiator include radical polymerization initiators and cationic polymerization initiators that can generate initiating species for each polymerization by energy. The energy herein refers to heat and/or energy rays (such as electromagnetic waves, light, and corpuscular rays).

Any radical polymerization initiator generating radicals by energy that is known to those skilled in the art can be used without limitation. Specifically, many initiators are described, for example, in Bruce M. Monroe, et al., Chemical Review, 93, 435 (1993), R. S. Davidson, Journal of Photochemistry and biology A: Chemistry, 73, 81 (1993), J. P. Faussier, “Photoinitiated Polymerization—Theory and Applications”: Rapra Review vol. 9, Report, Rapra Technology (1998), and M. Tsunooka, et al., Prog. Polym. Sci., 21, 1 (1996). Furthermore, a group of compounds in which oxidative or reductive bond cleavage occurs through interaction with an electronically excited state of a sensitizing dye is known, as those described in F. D. Saeva, Topics in Current Chemistry, 156, 59 (1990), G. G. Maslak, Topics in Current Chemistry, 168, 1 (1993), H. B. Shuster, et al., JACS, 112, 6329 (1990), and I. D. F. Eaton, et al., JACS, 102, 3298 (1980).

Examples of the radical polymerization initiator include (a) aromatic ketones, (b) aromatic onium salt compounds, (c) organic peroxides, (d) hexaaryl biimidazole compounds, (e) ketoxime ester compounds, (f) borate compounds, (g) azinium compounds, (h) metallocene compounds, (i) active ester compounds, (j) compounds having carbon-halogen bonds, and (k) acylphosphine oxide compounds.

Examples of the cationic polymerization initiator include benzoyl peroxides (BPO), peroxides of persulfate, azobisisobutylonitrile (AIBN), and dihydrazide isophthalate. Examples of cationic polymerization photoinitiators include onium salt cationic polymerization photoinitiators such as aromatic sulfonium salts, aromatic iodonium salts, aromatic diazonium salts, pyridium salts, and aromatic phosphonium salts; and non-ionic compounds such as iron arene complexes and sulfonates. Examples of cationic polymerization thermal initiators include protonic acids such as sulfonic acid, perchloric acid, and trichloroacetic acid; Lewis acids such as aluminum chloride, boron trifluoride, and ferric chloride; and other cation-producing compounds such as iodine and triphenyl hexachloroantimonate.

When the first ink composition contains the above-described polymerizable compound and polymerization initiator, the ink composition adhering to a recording medium can be cured by energy.

The first ink composition containing the above-described polymerizable compound and polymerization initiator may further contain a radical polymerization inhibitor. By doing so, the storage stability of the first ink composition can be increased. Examples of the radical polymerization inhibitor include Irgastab UV-10 and UV-20 (manufactured by Chiba Specialty Chemicals Inc.).

The first ink composition containing the above-described polymerizable compound and polymerization initiator may further contain a polymerization accelerator. The accelerator is not particularly limited, and examples thereof include Darocur EHA and EDB (manufactured by Chiba Specialty Chemicals Inc.).

In the first ink composition containing the above-described polymerizable compound and polymerization initiator, the cured product thereof can show a function of protecting an adhering substance from friction and the like when the first ink composition adheres onto a recording medium.

### (2-5) Surfactant

The first ink composition can contain a surfactant. Examples of the surfactant include silicone surfactants such and polyester-modified silicone and polyether-modified silicones; and other surfactants such as polyether-modified polydimethylsiloxanes and polyester-modified polydimethylsiloxanes.

The first ink composition may contain a nonionic surfactant as an additive. The nonionic surfactant makes the permeability of the first ink composition to a recording medium excellent to rapidly fix the ink composition on the recording medium in printing.

The nonionic surfactant is not particularly limited, and examples thereof include acetylene glycol surfactants. Examples of the acetylene glycol surfactant include BYK-UV 3570, BYK-UV 3500, BYK-UV 3510, BYK-UV 3530, BYK-347, and BYK-348 (manufactured by BYK Chemie Japan K.K.).

When the first ink composition contains a surfactant, the content of the surfactant is preferably from 0.1 to 5% by mass, further preferably from 0.2 to 2% by mass, based on the total mass of the ink composition. By regulating the content of the surfactant contained in the first ink composition to 0.1% by mass or more, the permeability of the ink composition to a recording medium can be increased. By regulating the content of the surfactant in the first ink composition to 5% by mass or less, an effect that a blur hardly occurs in the image formed by the ink composition on a recording medium is given.

### (2-6) Other Additives

The first ink composition can contain known or used components that can be used in common inks. Examples of such components include a wetting agent, a permeation solvent, a pH-adjusting agent, an antiseptic agent, and a fungicide. Furthermore, the first ink composition may contain, according to need, a leveling additive agent, a mat agent, and an agent for adjusting film physical properties, such as a polyester resin, a polyurethane resin, a vinyl resin, an acrylic resin, a rubber resin, or wax.

The first ink composition may further contain, for example, an antioxidant or an ultraviolet absorber.

Examples of the antioxidant include 2,3-butyl-4-oxyanisole (BHA) and 2,6-di-t-butyl-p-cresol (BHT). Examples of the ultraviolet absorber include benzophenone compounds and benzotriazole compounds.

### 1.3.2. Second Ink Composition

The second ink composition contains spherical particles and the same metallic pigment as that of the first ink composition. The metallic pigment contained in the second ink composition is common to that contained in the first ink composition. Therefore, both the first ink composition and the second ink composition can be produced without changing the type of the metallic pigment.

### 1.3.2. (1) Metallic Pigment

The metallic pigment contained in the second ink composition is the same as that described in the paragraph “1.3.1. (1) Metallic pigment” of the first ink composition, and therefore detail descriptions thereof are omitted.

### 1.3.2. (2) Spherical Particles

The spherical particles contained in the second ink composition have a function of imparting asperities to the glossy metallic surface formed by the metallic pigment contained in the second ink composition when the second ink composition adheres onto a recording medium. By this function, the second ink composition can form a glossy metallic surface having a degree of glossiness that is lower than that of the glossy metallic surface formed by the first ink composition (not containing spherical particles).

The spherical particles have an average particle size (diameter) of from 1 to 3 μm when the particles are approximated to spheres. By regulating the average diameter within this range, droplets of the second ink composition can be ejected by an ink jet recording apparatus. The average diameter of the spherical particles is further preferably from 1.5 to 2.5 μm.

The content of the spherical particles in the second ink composition has a preferred range of mass ratio with regard to the mass of the metallic pigment contained in the second ink composition. The mass ratio of the spherical particles and the metallic pigment is from 1:20 to 5:1, preferably from 1:15 to 10:3, and more preferably from 1:12 to 3:1. An increase in the amount of the spherical particles relative to the amount of the metallic pigment makes the resulting glossy metallic surface have a large amount of a diffuse reflection component, namely, a low degree of glossiness. Conversely, a decrease in the amount of the spherical particles relative to the amount of the metallic pigment makes the resulting glossy metallic surface have a small amount of diffuse reflection component, namely, a high degree of glossiness.

The spherical particles have shapes similar to spheres. The shape of a spherical particle can be evaluated by, for example, a sphericity index S denoted by the following equation.

Sphericity index S=particle minimum radius rₘᵢₙ/particle maximum radius rₘₐₓ.

Here, the rₘᵢₙ refers to the minimum distance from the center of gravity to the surface of a particle, and the rₘₐₓ refers the maximum distance from the center of gravity to the surface of the particle. Here, the center of gravity may be the center of a circumscribed sphere of the particle.

The spherical particles, as long as they have approximately sphere shapes, can provide a glossy metallic surface having diffuse reflectivity to an adhering substance when the second ink composition adheres to a recording medium. A shape more similar to a sphere can form a glossy metallic surface having diffuse reflectivity with higher texture. When the shape of a spherical particle is shown by the above-defined sphericity index S, the sphericity index S of the spherical particle is preferably from 0.8 to 1, more preferably from 0.9 to 1.

The spherical particles may be optically transparent. Here, the term “optical transparency” refers to that a flat plate formed of the material is optically transparent. Therefore, the term “optical transparency” refers to that, when light rays, such as ultraviolet rays, visible rays, or infrared rays, enter a flat plate formed of the material, the transmissivity is high in at least a part of wavelength range of the light rays. For example, when light rays that enter a flat plate formed of the material are visible rays, the term “optical transparency” refers to colorless transparency or colored transparency. In addition, in the embodiment, the material of the spherical particles may contain a light-scattering substance, and when light rays that enter a flat plate formed of the material are visible rays, the term “optical transparency” contains colorless translucency and colored translucency.

The material of the spherical particles is not particularly limited. Specific examples of the spherical particle material of the embodiment include glass, silicone resins, acrylic resins, and styrene resins. These materials may be colored or not. When a colored material is used, the resulting recorded matter can be provided with retroreflectivity and color.

The spherical particles contained in the second ink composition can be produced by, for example, dispersing a precursor of the desired material in a proper solvent, polymerizing the precursor by a method such as suspension polymerization or emulsion polymerization, and removing the solvent according to need.

Examples of commercially available spherical particles contained in the second ink composition include particles available from Nissho Sangyo Co., Ltd. under trade names, for example, Tospearl 120, 130, 145, 2000B, and VC99-A8808.

### 1.3.2. (3) Additional Components

The second ink composition of the embodiment may contain additional components such as a color material, a dispersing agent, an organic solvent, a polymerizable compound, a polymerization initiator, and a surfactant. The additional components that may be contained in the second ink composition are the same as those in the first ink composition. The descriptions in the paragraphs from 1.3.1. (2-1) to 1.3.1. (2-6) for the first ink composition are applied to the second ink composition, and detail descriptions thereof are omitted.

### 1.3.3. Third Ink Composition

In the ink jet recording method of the embodiment, at least the first ink composition and the second ink composition are charged on an ink jet recording apparatus, and a third ink composition may be further charged on the ink jet recording apparatus.

The third ink composition contains a metallic pigment and spherical particles. The metallic pigment is the same as that of the first ink composition, and the spherical particles are the same as those of the second ink composition. Accordingly, the first ink composition, the second ink composition, and the third ink composition can be produced without changing the types of the metallic pigment and the spherical particles thereof. The metallic pigment contained in the third ink composition is the same as that described in the paragraph “1.3.1. (1) Metallic pigment” of the first ink composition, and therefore detail descriptions thereof are omitted. The spherical particles contained in the third ink composition are the same as those described in the paragraph “1.3.2. (2) Spherical particles” of the second ink composition, and therefore detail descriptions thereof are omitted.

The content of the spherical particles contained in the third ink composition is different from that of the spherical particles contained in the second ink composition. By doing so, the glossy metallic surface formed by the third ink composition can have a different degree of glossiness from that of the glossy metallic surface formed by the second ink composition. That is, the use of the first, second, and third ink compositions makes it possible to form, by a single recording process, three types of glossy metallic surfaces having different degrees of glossiness from one another on a recording medium.

### 1.3.4. Others

In the above, as the ink compositions used in the ink jet recording method, the first, second, and third ink compositions have been described. In the ink jet recording method of the invention, the ink compositions are not limited thereto, and another ink composition containing a metallic pigment and spherical particles can be used within the range in which the ink composition can be charged on an ink jet recording apparatus used. By doing so, the number of stages in the degree of glossiness of glossy metallic surfaces can be increased. In addition, in such a case, the content of the spherical particles in each ink composition can be different from one another.

### 1.3.5. Preparation Process of Each Ink Composition

The preparation process of each ink composition in the embodiment is not particularly limited. For example, each ink composition can be prepared by sufficiently mixing components to be contained in the ink composition so as to be as uniform as possible, subjecting the mixture to pressure filtration through a membrane filter with 5 μm pore size, and deaerating the resulting filtrate using a vacuum pump according to need.

### 1.3.6. Physical Properties of Ink Composition

Each ink composition of the embodiment is one for ink jet recording applied to an ink jet recording apparatus. Accordingly, the viscosity of each composition is preferably from 1 to 20 mPa·s at 20° C. and is more preferably from 2 to 15 mPa·s, more preferably from 3 to 12 mPa·s at 20° C. The ink composition having a viscosity within the range above can be further suitably applied to an ink jet recording apparatus, and a proper amount of the composition can be ejected from a nozzle, and curved flying and scattering of the composition can be further reduced. The ink composition having a viscosity within the range above can ensure ejection stability of the ink composition ejected by the above-described ink jet recording apparatus so as to adhere onto a recording medium. The viscosity of each ink composition can be adjusted by controlling the amount of each component.

### 1.4. Function and Effect

According to the ink jet recording method described above, an image is recorded by ejecting droplets of at least the first ink composition and the second ink composition using an ink jet recording apparatus to make the droplets adhere to a recording medium. The first ink composition contains a metallic pigment, and the second ink composition contains the metallic pigment and spherical particles. Accordingly, glossy metallic surfaces having different degrees of glossiness can be readily formed on the recording medium by a single recording process.

### 2. Recorded Matter

The recorded matter of the embodiment is one in which an image is recorded on a recording medium by the above-described ink jet recording method. The recorded matter of the embodiment has glossy metallic surfaces having different degrees of glossiness from one another.

The term “degree of glossiness” of a glossy metallic surface herein refers to the degree of light that is regularly reflected when the light is incident on an object. The degree of glossiness of a glossy metallic surface can be evaluated by, for example, the following method. Light from a light source is made incident on a measurement point of an image at an incidence angle of 45° using a goniophotometer, and the light that is reflected (diffuse reflection) in the direction of the right above the measurement point (incidence angle: 0° is detected by a detector. Here, the term “incidence angle of 45°” refers to that an inclination of the axis of incident light is 45° when the vertical direction with respect to the recording surface is defined as 0°. In this case, the detector detects part of light diffusely reflected by the glossy metallic surface (measurement point). Therefore, the higher the degree of glossiness of the measurement point is, the smaller the intensity of the diffusely reflected light detected by the detector is. Conversely, the larger the intensity of the diffusely reflected light detected by the detector is, the lower the degree of glossiness of the measurement point is. The light intensity detected by the detector can be digitized by, for example, the Y-component indicating brightness in an XYZ color system.

### 3. Ink Set

As an ink set according to the embodiment, one that is provided with the first ink composition and the second ink composition described in the paragraph of “1.3. Ink composition” is exemplified.

The ink set is provided with the first ink composition and the second ink composition and may further include one or a plurality of other ink compositions (for example, the third ink composition). Examples of the other ink compositions that can be provided to the ink set include color ink compositions such as cyan, magenta, yellow, light cyan, light magenta, dark yellow, red, green, blue, orange, and violet; black ink compositions; and light-black ink compositions.

### 4. Ink Cartridge and Ink Jet Recording Apparatus

As the ink cartridge according to the embodiment, one that is provided with the ink set above is exemplified. With the cartridge, the ink set including the above-described ink compositions can be easily conveyed. The ink jet recording apparatus according to the embodiment is provided with the ink cartridge, and as the ink jet recording apparatus, one that is described in the paragraph “1.1. Ink jet recording apparatus” is exemplified.

### 5. Examples

The invention will now be described in detail with reference to Examples, but is not limited thereto.

### 5.1. Ink Composition

### 5.1.1. Preparation of Metallic Pigment Dispersion

A resin layer thin film was formed on a PET film having a thickness of 100 μm by uniformly applying a resin layer coating liquid (diethylene glycol diethyl ether containing 10% by weight of a CAB resin having a butylation rate of 50 to 54% and a molecular weight of 16000) onto the PET film by bar coating, followed by drying at 60° C. for 10 minutes.

Then, an aluminum deposition layer having an average thickness of 20 nm was formed on the resin layer thin film using a vacuum deposition apparatus (model VE-1010 vacuum deposition apparatus manufactured by Vacuum Device Inc.). The ultraviolet transmissivity at this thickness was 8% at a 365 nm wavelength and 0.8% at a 395 nm wavelength.

Then, the laminate formed by the above-described method was immersed in ethylene glycol monoallyl ether, and the aluminum deposition layer was peeled from the PET film using a ultrasonic disperser model VS-150 (manufactured by As One Corporation). Furthermore, several sheets of the PET film having the aluminum deposition layer were similarly subjected to immersion and peeling, followed by concentration. With the concentration, aluminum deposition layers were pulverized while adjusting the ultrasound intensity. At the same time, the aluminum deposition layers were reduced in size and dispersed in the solvent. The ultrasonic dispersion treatment was carried out for 12 hours to prepare a metallic pigment dispersion.

The resulting metallic pigment dispersion was filtered through an SUS mesh filter with 5 μl pore size to remove coarse particles. Then, the filtrate was put in a round-bottomed flask, and an excess of ethylene glycol monoallyl ether was evaporated using a rotary evaporator. By doing so, the metallic pigment dispersion was concentrated. The concentration of the metallic pigment dispersion was controlled while measuring the concentration of the metallic pigment with a thermo mechanical analyzer (model EXSTAR-6000TG/DTA manufactured by SII Nano Technology Inc.) to give 5% by mass of metallic pigment dispersion.

The 50% average particle size R50 based on a circle-equivalent diameter of the X (major axis) −Y (minor axis) plane of the metallic pigment was measured using a particle size and particle size distribution analyzer (FPIA-3000S, manufactured by Sysmex Corp.). Furthermore, R50/Z was calculated from the resulting R50 and a measurement value Z (thickness). As the results, the metallic pigment had an R50 of 1.03 μm and an R50/Z of 51.5.

### 5.1.2. Preparation of Exemplary Ink Composition

To the metallic pigment dispersion prepared above, organic solvents (diethylene glycol diethyl ether manufactured by Nippon Nyukazai Co., Ltd., γ-butyrolactone manufactured by Kanto Chemical Co., Ltd., and tetraethylene glycol dimethyl ether manufactured by Nippon Nyukazai Co., Ltd.) and spherical particles (available from Nissho Sangyo Co., Ltd. under trade name Tospearl 120 having an average diameter of 2 μm) were added at the amounts shown in Table 1. The resulting mixtures were sufficiently mixed and stirred to give the ink compositions for each Example. Ink compositions were prepared under the same conditions except that the ink composition in Example 1 did not contain the spherical particles and that the ink composition in Example 10 did not contain the metal pigment.

TABLE 1

| | | Example | | | | | | | | | |
|---|---|---|---|---|---|---|---|---|---|---|---|
| Unit: % by mass | | 1 | 2 | 3 | 4 | 5 | 6 | 7 | 8 | 9 | 10 |
| Metallic pigment | | 1.5 | 1.5 | 1.5 | 1.5 | 1.5 | 1.5 | 1.5 | 1.5 | 1.5 | — |
| Spherical particle | | — | 0.1 | 0.2 | 0.5 | 0.8 | 1.00 | 2.0 | 3.0 | 5.0 | 5.0 |
| Organic solvent | Diethylene glycol diethyl ether | 65.5 | 65.4 | 65.3 | 65.0 | 64.8 | 64.5 | 63.5 | 62.5 | 60.5 | 62.0 |
| | γ-Butyrolactone | 15.0 | 15.0 | 15.0 | 15.0 | 15.0 | 15.0 | 15.0 | 15.0 | 15.0 | 15.0 |
| | Tetraethylene glycol dimethyl ether | 18.0 | 18.0 | 18.0 | 18.0 | 18.0 | 18.0 | 18.0 | 18.0 | 18.0 | 18.0 |

| | | | | | | | | | | |
|---|---|---|---|---|---|---|---|---|---|---|
| Diffuse reflection component (%) | 3.7 | 3.7 | 3.6 | 4.2 | 4.5 | 5 | 7.1 | 6.7 | 8.9 | — |

### 5.2. Recording Medium

The recording medium used in Examples was SPVC-1270T having an average surface roughness Ra of 0.89 μm available from Roland D.G. Corp.

### 5.3. Specimen for Evaluation and Evaluation

Specimens for evaluation of Examples were prepared as follows.

Each ink composition was introduced to the respective mat black columns of an ink jet printer, PX-G5100, manufactured by Seiko Epson Corp. Solid printing of 10 cm×10 cm was carried out on a recording medium using the ink compositions at an ink amount of 0.9 mg/cm².

Then, the degree of glossiness of the printing area was measured with a goniophotometer and was evaluated by the diffuse reflection component D according to the following equation (1). Table 1 shows the values of the diffuse reflection component D. Note that a larger value of the diffuse reflection component represents a lower degree of glossiness.

D=Yd/Ys (1)

In the equation, Yd and Ys respectively denote the brightness of a diffuse reflection component and the brightness of a regular reflection component, in reflected light when the light was incident on an image at an incidence angle of 45°.

Specifically, the specimen for evaluation of the ink composition of each Example was set to a goniophotometer, and light from a light source was made incident on a glossy metallic surface (solid printing area) of the specimen at an incidence angle of 45°. At this state, a detector was moved in the direction of the right above (0°) the measurement point, and the light reflected by the specimen was detected. The detected light was digitized by the Y-component indicating brightness in an XYZ color system as the brightness Yd of the diffuse reflection component D. Furthermore, while keeping the state that the light from the light source was made incident on the glossy metallic surface (solid printing area) of the specimen at an incidence angle of 45°, the detector was moved to the opposite side) (−45°) in the direction of the incidence axis, and the regular reflection light reflected by the specimen was detected. The detected regular reflection light was digitized by the Y-component indicating brightness in an XYZ color system as the brightness Ys of the regular reflection component. By using the thus-obtained Yd and Ys, the value D was calculated. The goniophotometer used was model GC-5000 manufactured by Nippon Denshoku Industries Co., Ltd.

### 5.4. Evaluation Result

With reference to Table 1, it was seen that the diffuse reflection component D was increased with the content of the spherical particles when the metallic pigment was contained and the content of the spherical particles was varied (Examples 1 to 9). In Examples 1 to 9, the mass ratios of the spherical particles to the metallic pigment (spherical particles:metallic pigment) were varied from 1:15 to 10:3. It was revealed that the value of the diffuse reflection component D was continuously varied as long as the content of the spherical particles was within the range above. The FIGURE shows these results plotted in a graph whose horizontal axis is the content of the spherical particles and whose vertical axis is the value of the diffuse reflection component D. In the graph of the FIGURE, the specular glossiness of each recorded matter was also plotted. The value of the specular glossiness is 60° specular glossiness measured according to Japanese Industry Standard (JIS) 28741: 1997 with a gloss meter, model VGP5000, manufactured by Nippon Denshoku Industries Co., Ltd.

With reference to the FIGURE, it has been revealed that there is a negative correlation between the value of the diffuse reflection component D and the 60° specular glossiness and that the glossiness continuously changes with the content of the spherical particles.

On the other hand, the specimen in Example 10, which did not contain the metallic pigment, was visually evaluated to reveal that the specimen did not have metallic glossiness, and the measurement thereof also showed that no meaningful values of the diffuse reflection component D and the 60° specular glossiness were obtained.

From the experimental results above, it has been seen that the degree of metallic glossiness of a recorded matter can be easily and arbitrarily changed by changing the concentration of the spherical particles in an ink composition containing a metallic pigment. Accordingly, it has been revealed that the ink jet recording method of the invention can readily form an image having glossy metallic surfaces with different degrees of glossiness from one another on a recording medium by a single recording process using an arbitrary combination of a plurality of such ink compositions.

The invention is not limited to the above-described embodiment, and various modifications are applicable. For example, the invention includes substantially the same configurations as those described in the embodiment (for example, configurations having the same functions, processes, and results, or configurations having the same purposes and effects). Furthermore, the invention includes configurations in which portions not being essential of the configurations described in the embodiment are substituted. Furthermore, the invention includes configurations that can achieve the same effects or purposes as those of the configurations described in the embodiment. Furthermore, the invention includes configurations in which publicly known technology is added to the configurations described in the embodiment.

What is claimed is:

1. An ink jet recording method for recording an image by ejecting droplets of a plurality of types of ink compositions and making the droplets adhere to a recording medium using an ink jet recording apparatus, wherein
the ink jet recording apparatus is provided with at least a first ink composition and a second ink composition, wherein
the first ink composition contains a metallic pigment; and
the second ink composition contains the metallic pigment and spherical particles having an average diameter of from 1 to 3 μm.

2. The ink jet recording method according to claim 1, wherein
the ink jet recording apparatus is further provided with a third ink composition containing the metallic pigment and the spherical particles, wherein
the third ink composition contains the spherical particles at a content different from that of the spherical particles in the second ink composition.

3. The ink jet recording method according to claim 1, wherein
the second ink composition and the third ink composition each independently contain the spherical particles and the metallic pigment at a mass ratio of from 1:15 to 10:3.

4. The ink jet recording method according to claim 1, wherein
the recording medium has a recording surface having an average surface roughness Ra of 0.5 μm or less.

5. The ink jet recording method according to claim 1, wherein
the first ink composition, the second ink composition, and the third ink composition each independently contain the metallic pigment at a content of from 0.5 to 3% by mass based on the total mass of the respective ink composition.

6. The ink jet recording method according to claim 1, wherein
the metallic pigment is a plate-like particle composed of aluminum or an aluminum alloy and having a flat surface with a major axis X, a minor axis Y, and a thickness Z that satisfy the requirements that the 50% average particle size R50 based on a circle-equivalent diameter determined from the X-Y plane area of the plate-like particle is from 0.5 to 3 μm and R50/Z>5.

7. The ink jet recording method according to claim 1, wherein
at least one of the first ink composition, the second ink composition, and the third ink composition further contain a color material.

8. The ink jet recording method according to claim 1, wherein
the first ink composition, the second ink composition, and the third ink composition each independently have a viscosity of from 2 to 15 mPa·s at 20° C.

9. A recorded matter comprising an image recorded on a recording medium by the ink jet recording method according to claim 1.

10. An ink set comprising a plurality of types of ink compositions used in the ink jet recording method according to claim 1.

11. An ink cartridge comprising the ink set according to claim 10.

12. An ink jet recording apparatus comprising the ink cartridge according to claim 11.
